(19) United States
(12) Patent Application Publication
(10) Pub. No.: US 2010/0207813 A1
(43) Pub. Date: Aug. 19, 2010

(54) FREQUENCY VARIATION DETERMINING METHOD, AND SATELLITE POSITIONING SYSTEM UTILIZING THE METHOD

(76) Inventors: Chi-Ya Lo, Taoyuan County (TW); Hsin-Chung Yeh, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/372,745

(22) Filed: Feb. 18, 2009

(51) Int. Cl. G01S 1/00

(52) U.S. Cl. 342/357.12; 342/357.06

(57) ABSTRACT

A frequency variation determining method determines a frequency variation of a target signal of a chip. The method comprises: (a) determining an operation state according to a plurality of chip state parameters; and (b) determining the frequency variation of the target signal according to the operation state.

### BACKGROUND OF THE INVENTION

The present invention relates to a frequency variation determining method and a satellite positioning system utilizing the methods, and particularly relates to a frequency variation determining method utilizing at least a chip state parameter and a satellite positioning system utilizing the methods.

A satellite positioning system such as a GPS system comprises an oscillator for providing a clock signal to the devices in the system. However, the frequency of the oscillator will vary due to different temperature, as shown in FIG. 1. FIG. 1 is a schematic diagram illustrating an S-curve indicating the relations between the frequency variation of the clock signal, which is generated from the oscillator, and temperature. It is apparent that the frequency variation changes corresponding to different temperature. Therefore, the operation of the satellite positioning system will be affected accordingly, if no compensation for this situation is performed.

A TCXO (temperature compensating oscillator) can be utilized to compensate, however, the cost and the occupied area region of TCXO is much higher than a normal oscillator, which increases the difficulty for designing a system and the cost for manufacturing a satellite positioning system.

### SUMMARY OF THE INVENTION

One embodiment of the present invention discloses a frequency variation determining method for determining a frequency variation of a target signal of a chip. The method comprises: (a) determining an operation state according to a plurality of chip state parameters; and (b) determining the frequency variation of the target signal according to the operation state.

Another embodiment of the present invention discloses an oscillator, a chip, and a processor. The chip includes an IF down converter, an ADC, a baseband generator and a PLL. The oscillator generates a clock signal. The chip receives a satellite signal to generate a baseband signal according to the clock signal. The IF down converter down converts an RF signal to generate a first signal. The ADC converts the first signal to a second signal. The baseband signal generator converts the second signal to a baseband signal. The PLL generates a third signal according to the clock signal. The processor determines an operation state according to a plurality of chip state parameters and determines the frequency variation of at least one of the first signal, the second signal and the third signal according to the operation state.

According to above-mentioned embodiments, the frequency variation due to temperature or other chip parameters can be compensated without utilizing a TCXO. Thus the issue described in the related art can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an S-curve indicating the relation between the frequency variation of the clock signal, which is generated from the oscillator, and temperature.

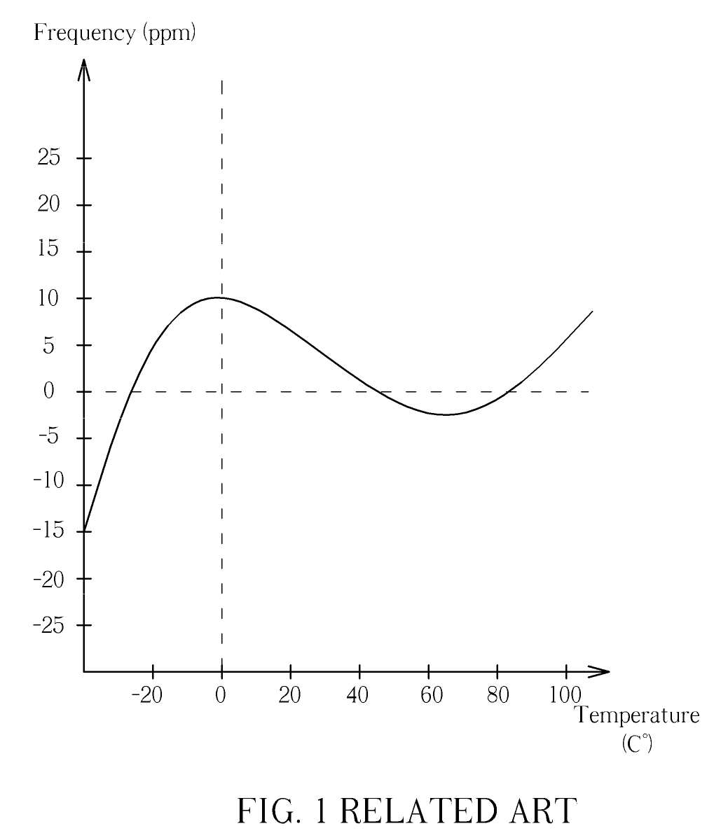

FIG. 2 is a block diagram illustrating a satellite positioning system utilizing a frequency variation calibrating method and a frequency variation computing method according to embodiments of the present invention.

FIG. 3 is a schematic diagram illustrating the steps of selecting an operation state of the chip according to chip state parameters.

FIG. 4 is a schematic diagram illustrating the steps of acquiring the frequency variation and the searching range of the satellite according to the selected operation state.

FIG. 5 is a flowchart illustrating a frequency variation calibrating method according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

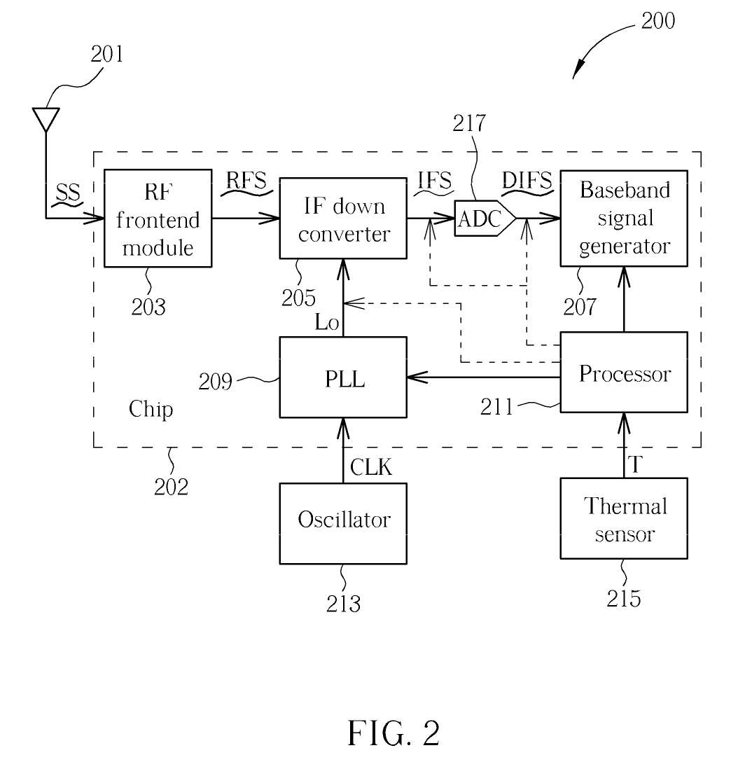

FIG. 2 is a block diagram illustrating a satellite positioning system 200 utilizing a frequency variation calibrating method and a frequency variation computing method according to embodiments of the present invention. It should be noted that the devices shown in FIG. 2 are only for example and do not mean to limit the scope of the present invention to the devices shown in FIG. 2.

As shown in FIG. 2, the satellite positioning system 200 comprises an antenna 201, a RF front end module 203, a IF down converter 205, a baseband signal generator 207, a PLL 209, a processor (central processing unit) 211, an oscillator 213, and a thermal sensor 215. The antenna 201 serves to receive a satellite signal SS. The RF front end module 203 serves to generate a RF signal RFS according to the satellite signal SS. The IF down converter 205 serves to down convert the RF signal to generate an IF signal IFS. The baseband signal generator 207 serves to generate a baseband signal BS according to the IF signal IFS. The PLL 209 serves to generate a local oscillating signal LO according to a clock signal CLK. The processor 211 serves to control operation of the satellite positioning system 200 and perform the frequency variation compensation steps. The oscillator 213 serves to provide the clock signal CLK. The thermal sensor 215 serves to detect a temperature T of a chip 202 comprising the RF front end module 203, an IF downconverter 205, a baseband signal generator 207, a PLL 209, and a processor (central processing unit) 211.

After receiving the temperature T from the thermal sensor 215, the processor 211 can perform frequency variation compensation steps according to the temperature T. The frequency variation compensation steps can be performed to the local oscillating signal LO. In this case, the processor 211 can vary parameters of the PLL 209, and thus the frequency of LO can be changed accordingly. Additionally, if the satellite positioning system 200 comprises an ADC (analog to digital converter) 217 located between the IF downconverter 205 and the baseband signal generator 207, the frequency variation compensation steps can be performed to the IF signal IFS or a digital IF signal DIFS, which is generated via the ADC 217 according to the IF signal IFS. In this case, the processor 211 adjusts the parameters of a voltage control oscillator in the baseband signal generator 207 to compensate for the frequency variation. Briefly, frequency variation compensation steps can be performed to a target signal, which can be the local oscillating signal LO, the IF signal IFS or the digital IF signal DIFS.

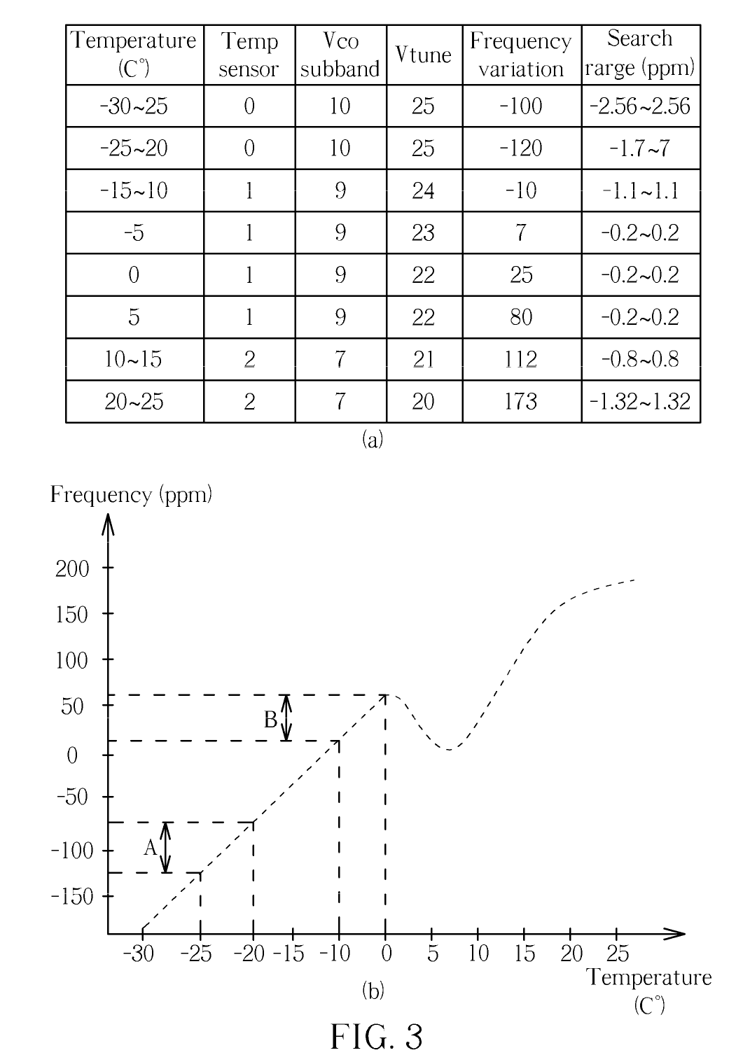

In this embodiment, the chip 202 has a plurality of operation states corresponding to different temperatures and other parameters of the chip. Also, an operation state is selected according to the measured temperature T, and the frequency variation compensation steps are performed according to the selected operation state. FIG. 3 is a schematic diagram illustrating the steps of selecting an operation state of the chip according to chip state parameters. As shown in FIG. 3, the chip state parameters can comprise parameters besides the temperature, such as a VCO sub-band parameter, and a Vₜᵤₙₑ parameter. The VCO sub-band parameter indicates the range that a VCO (voltage control oscillator) in the baseband signal generator 207 can support (i.e. the range of a sub-band). The Vₜᵤₙₑ parameter indicates the number of sub-bands that can be utilized. By this way, the operation state of the chip can be acquired once the current temperature, the VCO sub-band parameter, and the Vₜᵤₙₑ parameter are obtained.

For example, if the current temperature is −22° C., and the VCO sub-band parameter and the Vtune parameter are respectively 10 and 25, it can be determined that the chip operates in the operation state A and the frequency variation and the search range can be computed accordingly. Similarly, if the current temperature is −5° C., and the VCO sub-band parameter and the Vₜᵤₙₑ parameter are respectively 9 and 23, it can be determined that the chip operates in the operation state B and the frequency variation and the search range can be computed accordingly.

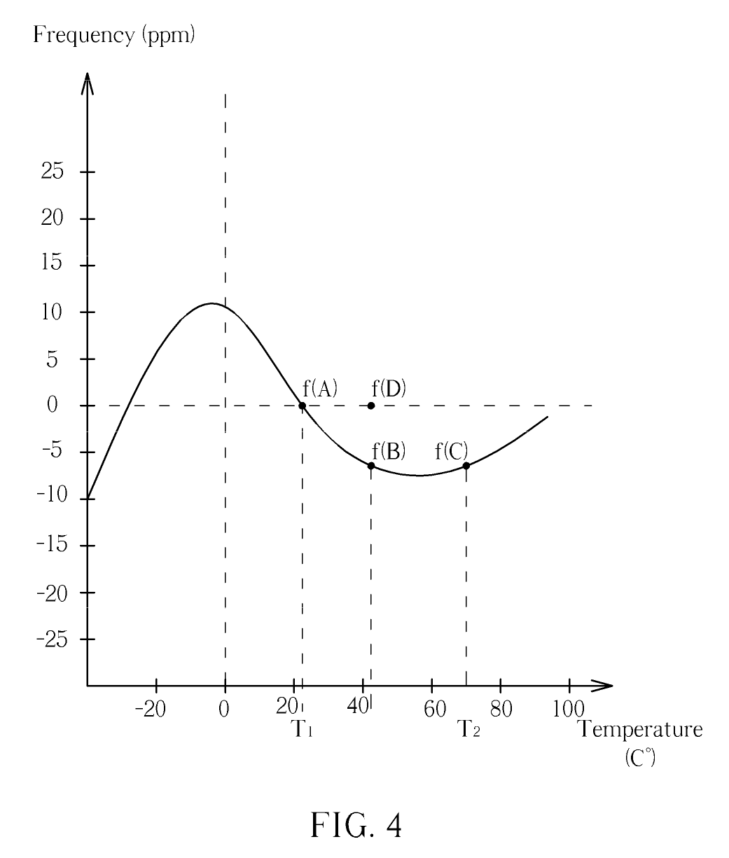

FIG. 4 is a schematic diagram illustrating the steps of acquiring the frequency variation and the searching range of the satellite according to the selected operation state. As shown in FIG. 4, f(A) indicates a frequency corresponding to a extreme value temperature T₁, f(C) indicates a frequency corresponding to a extreme value temperature T₂, and f(D) indicates a value where no frequency variation occurs. The frequency variation range can be determined according to the equation

$$\pm \frac{\vert f ( A ) - f ( C ) \vert}{2} .$$

Additionally, a center frequency f(B) can be computed according to the equation

$$\frac{f ( A ) + f ( C )}{2} .$$

After f(B) is computed, the frequency bias can be acquired via the equation f(D)-f(B). Then, the frequency variation can be determined according to the frequency variation range

$$\pm \frac{\vert f ( A ) - f ( C ) \vert}{2}$$

and the frequency bias f(D)-f(B).

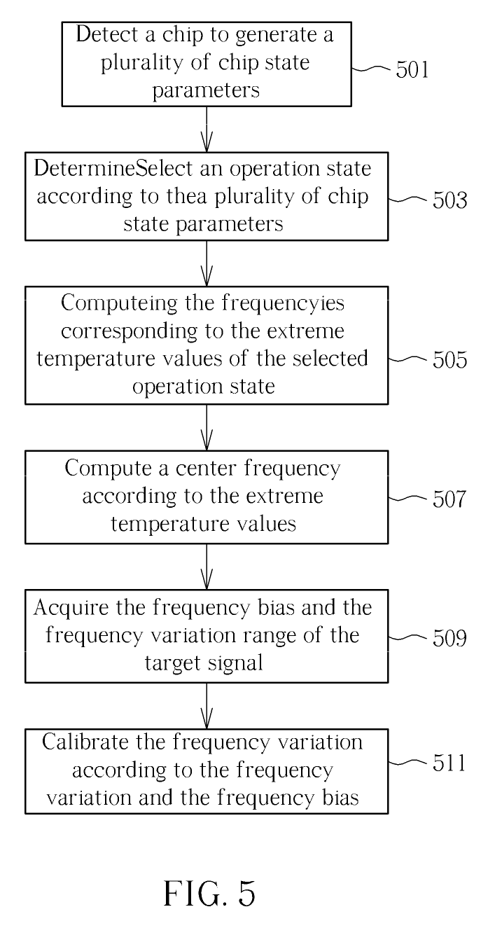

FIG. 5 is a flowchart illustrating a frequency variation calibrating method according to an embodiment of the present invention. The method comprises:

Step 501

Detect a chip to generate a plurality of chip state parameters.

Step 503

Determine an operation state according to a plurality of chip state parameters.

Step 505

Compute the frequencies (i.e f(A), f(C) in FIG. 4) corresponding to the extreme temperature values of the selected operation state.

Step 507

Compute a center frequency (i.e. f(B) in FIG. 4) according to the extreme temperature values.

Step 509

Acquire the frequency bias and the frequency variation range of the target signal according to the frequencies corresponding to the extreme temperature values and the center frequency.

Step 511

Calibrate the frequency variation according to the frequency variation range and the frequency bias.

Other detailed characteristics are illustrated in the above-mentioned embodiments, and thus are omitted for brevity. Please note that steps 501˜509 can further be regarded as a frequency variation computing method according to an embodiment of the present invention.

According to the above-mentioned embodiments, the frequency variation due to temperature or other chip parameters can be compensated without utilizing a TCXO. Thus the issue described in the related art can be avoided.

Those skilled in the art will readily observe that numerous modifications and alterations of the device and method may be made while retaining the teachings of the invention.

What is claimed is:

1. A frequency variation determining method for determining a frequency variation of a target signal of a chip, comprising:
(a) determining an operation state according to a plurality of chip state parameters; and
(b) determining the frequency variation of the target signal according to the operation state.

2. The method of claim 1, wherein the chip state parameters comprise a temperature of the chip.

3. The method of claim 1, wherein the chip comprises a voltage control oscillator, wherein the chip state parameters comprise a VCO sub-band parameter, or a Vₜᵤₙₑ parameter, wherein the VCO sub-band parameter indicates the range that the voltage control oscillator can support, and the Vₜᵤₙₑ parameter indicates the number of sub-bands that can be utilized.

4. The method of claim 1, wherein the chip comprises a voltage control oscillator, and the chip state parameters further comprises a frequency range that the voltage control oscillator can support.

5. The method of claim 1, wherein the step (b) comprises:
obtaining frequency variation range and frequency bias corresponding to the operation state; and
obtaining the frequency variation of the target signal according to the frequency variation range and frequency bias.

6. The method of claim 1, wherein the chip is for a satellite positioning system, and the method further comprising:
determining a satellite searching range of the satellite positioning system according to the frequency variation.

7. The method of claim 6, wherein the satellite positioning system comprises an oscillator for generating a clock signal, and the method further comprises:
generating the target signal according to the clock signal; and
down converting an RF signal according to the target signal.

8. The method of claim 6, further comprising:
down converting an RF signal to generate the target signal;
converting the target signal to a digital IF signal; and
converting the digital IF signal to a baseband signal.

9. The method of claim 6, further comprising:
down converting an RF signal to generate an IF signal;
converting the IF signal to the target signal; and
converting the target signal to a baseband signal.

10. A satellite positioning system, comprising:
an oscillator for generating a clock signal;
a chip, for receiving a satellite signal to generate a baseband signal according to the clock signal, comprising:
an IF down converter, for down converting an RF signal to generate a first signal;
an ADC, for converting the first signal to a second signal; and
a baseband signal generator, for converting the second signal to the baseband signal;
a PLL, for generating a third signal according to the clock signal; and
a processor, for determining an operation state according to a plurality of chip state parameters and for determining the frequency variation of at least one of the first signal, the second signal and the third signal according to the operation state.

11. The system of claim 10, wherein the chip state parameter detector is a thermal detector and the chip state parameter comprises a temperature of the chip.

12. The system of claim 10, wherein the chip includes a voltage control oscillator, and the chip state parameters comprise a VCO sub-band parameter, or a Vₜᵤₙₑ parameter, wherein the VCO sub-band parameter indicates the range that the voltage control oscillator can support, and the Vₜᵤₙₑ parameter indicates the number of sub-bands that can be utilized.

13. The system of claim 10, wherein the chip has a plurality of operation states corresponding to different chip state parameters.

14. The system of claim 13, wherein the processor further obtains frequency variation range and frequency bias corresponding to the operation state, and obtains the frequency variation of the target signal according to the frequency variation range and frequency bias.
